(19) United States
(12) Patent Application Publication
(10) Pub. No.: US 2018/0281698 A1
(43) Pub. Date: Oct. 4, 2018

(54) VEHICULAR CAMERA CALIBRATION SYSTEM

(71) Applicant: MAGNA ELECTRONICS INC., Auburn Hills, MI (US)

(72) Inventors: Minwei Tang, Stuttgart (DE); Jagmal Singh, Aschaffenburg (DE); Sven Berndt, Aschaffenburg (DE)

(21) Appl. No.: 15/941,036

(22) Filed: Mar. 30, 2018

Related U.S. Application Data
(60) Provisional application No. 62/479,458, filed on Mar. 31, 2017.

(51) Int. Cl. B60R 11/04; G06T 7/80; H04N 7/18

(52) U.S. Cl. CPC B60R 11/04; G06T 7/80; H04N 7/18; G06T 2207/30252; B60R 2300/303; B60R 2300/402; B60R 2300/105

(57) ABSTRACT

A camera calibration system for cameras of a vehicle includes a plurality of cameras disposed at a vehicle and having respective fields of view exterior of the vehicle. The fields of view of at least two of the cameras overlap. An image processor is operable to process image data captured by the cameras to determine features in the overlapping regions of the fields of view of the at least two cameras. The camera calibration system determines a best fitting camera model based on actual geometric properties of each of the cameras. A display screen is disposed in the vehicle for displaying images derived from image data captured by the at least two cameras for viewing by a driver of the vehicle. Responsive to determining a best fitting camera model, the display screen displays images derived from image data captured by the at least two cameras.

### CROSS REFERENCE TO RELATED APPLICATION

The present application claims the filing benefits of U.S. provisional application Ser. No. 62/479,458, filed Mar. 31, 2017, which is hereby incorporated herein by reference in its entirety.

### FIELD OF THE INVENTION

The present invention relates generally to a vehicle vision system for a vehicle and, more particularly, to a vehicle vision system that utilizes two or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

In a surround view system, cameras are mounted on front, rear, left and right side of the vehicle, and images from all four (or more) cameras are stitched to generate a top-view/bowl-view/3D view or the like. The quality of stitching of the images for display is generally poor due to offsets in camera actual position and orientation after assembly and installation of the system. Stitching quality is improved by calibrating extrinsic parameters of all cameras (using offline or online calibration methods). A metric is typically desired to have the online objective evaluation of stitching quality and this metric can be used as an output for the user, as well as an input for further improving the stitching quality.

To calibrate the cameras, the subject vehicle may be placed on a flat surface with pre-defined target laid over the stitching region(s). Images of the target are captured by the cameras and are analyzed in the top view to get a metric or confidence value for stitching quality. In some cases, the camera is calibrated in such a way to achieve best stitching quality offline.

### SUMMARY OF THE INVENTION

The present invention provides a driver assistance system or vision system or imaging system for a vehicle that utilizes one or more cameras (preferably one or more CMOS cameras) to capture image data representative of images exterior of the vehicle, and provides camera calibration system determines a best fitting camera model based on actual geometric properties of each of the cameras. A display screen is disposed in the vehicle for displaying images derived from image data captured by the cameras for viewing by a driver of the vehicle during a driving maneuver of the vehicle. In response to determining a best fitting camera model, the display screen displays images derived from the image data captured by at least some of the cameras.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

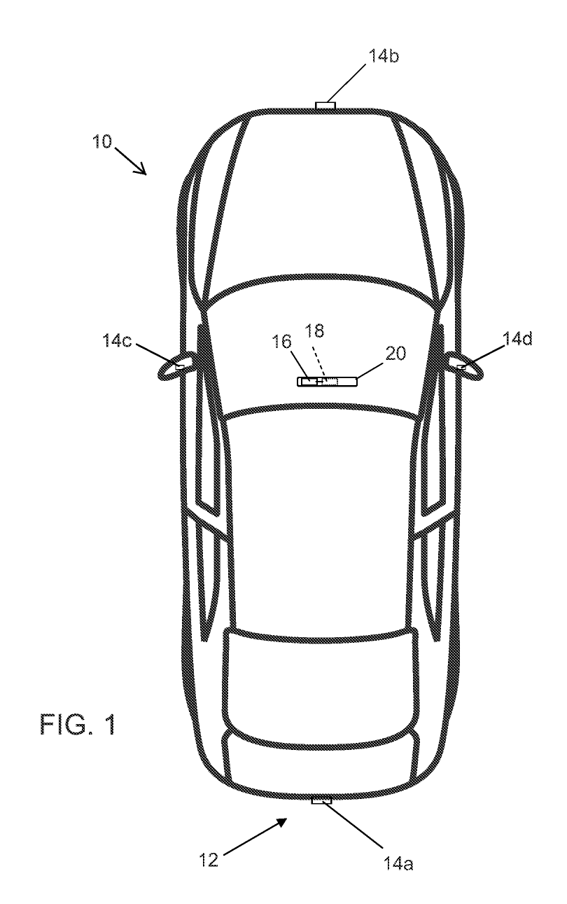

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The system may utilize aspects of the systems described in U.S. Pat. Nos. 9,491,451; 9,150,155; 7,914,187 and/or 8,421,865, and/or U.S. Publication Nos. US-2017-0050672; US-2014-0247352; US-2014-0333729; US-2014-0176605; US-2016-0137126; US-2016-0148062 and/or US-2016-0044284, which are hereby incorporated herein by reference in their entireties.

The imaging sensors or cameras of the vision system 12 may include a “fish-eye” camera or lens. Such a camera provides an ultra-wide-angle field of view (greater than 180 degrees). This allows for fewer number of cameras to be used to cover the views around the vehicle. Such cameras break the rectilinearity of the scene by introducing a very strong curvilinear distorting effect and frequently suffer from accuracy and image quality concerns. Aspects of the present invention offers a means for calibrating a fish-eye camera to minimize distortion and maximize accuracy.

General Polynomial Model:

The following is an outline for a distortion model where a single polynomial function describes radial and tangential distortions and a suitable camera model for the calibration of automotive fish-eye cameras.

The complete geometry of a fish-eye camera can be generalized as a projection P of scene points from [symbol] ³ to [symbol] ², where [symbol] is the real numbers set, combined with distortions (Δu, Δv). Assuming that there is a scene point with the coordinates in camera reference frame (x, y, z), then its real image coordinates (u′, v′) ϵ [symbol] ² is the result of the projection plus the distortions:

$$( \begin{matrix}{u}^{′} \\ {v}^{′}\end{matrix} ) = P ( x , y , z ) + ( \begin{matrix}Δ u \\ Δ v\end{matrix} ) \qquad ( 1 )$$

While the ideally projected image point (u, v) without distortions is:

$$( \begin{matrix}u \\ v\end{matrix} ) = P ( x , y , z ) \qquad ( 2 )$$

Therefore, the distortions (Δu, Δv) can be defined as the difference of (u′, v′) and (u, v):

$$( \begin{matrix}Δ u \\ Δ v\end{matrix} ) = ( \begin{matrix}{u}^{′} \\ {v}^{′}\end{matrix} ) - ( \begin{matrix}u \\ v\end{matrix} ) \qquad ( 3 )$$

According to Weierstrass approximation theorem, any continuous function can be approximated by the Taylor polynomials of finite orders at a given interval [a, b] (a, b ϵ [symbol] ). Applying the theorem to cameras, the image area defines the rectangular domain, and there exists a bivariate polynomial function for the distortions:

$$( \begin{matrix}Δ u \\ Δ v\end{matrix} ) = f ( u , v ) = ( \begin{matrix}{\sum }_{i = 0 , j = 0}^{i = m , j = n} {a}_{ij} \cdot {u}^{i} {v}^{j} \\ {\sum }_{i = 0 , j = 0}^{i = n , j = m} {b}_{ij} \cdot {u}^{i} {v}^{j}\end{matrix} ) \qquad ( 4 )$$

Where u, v are the ideal image coordinates, Δu, Δv are the distortions of image coordinates, and aᵢⱼ, bᵢⱼ are the coefficients of polynomials. The upper bounds of summation m and n for Δu are switched for Δv. By introducing the bivariate terms the tangential distortion is incorporated. In fact, equation (4) subsumes Brown's radial and tangential models. With certain parameters selected and the others dropped the exact representation of Brown's model may be retrieved.

The rewritten function in matrix may be shown as:

$$Δ u = ( {u}^{0} {u}^{1} {u}^{2} … {u}^{m} ) ( \begin{matrix}{a}_{00} & {a}_{01} & … & {a}_{0 n} \\ {a}_{10} & {a}_{11} & … & {a}_{1 n} \\ {a}_{20} & {a}_{21} & … & {a}_{2 n} \\ ⋮ & ⋮ & ⋱ & ⋮ \\ {a}_{m 0} & {a}_{m 1} & … & {a}_{mn}\end{matrix} ) ( \begin{matrix}{v}^{0} \\ {v}^{1} \\ ⋮ \\ {v}^{n}\end{matrix} ) \\ Δ v = ( {u}^{0} {u}^{1} {u}^{2} … {u}^{n} ) ( \begin{matrix}{b}_{00} & {b}_{01} & … & {b}_{0 m} \\ {b}_{10} & {b}_{11} & … & {b}_{1 m} \\ {b}_{20} & {b}_{21} & … & {b}_{2 m} \\ ⋮ & ⋮ & ⋱ & ⋮ \\ {b}_{n 0} & {b}_{n 1} & … & {b}_{n m}\end{matrix} ) ( \begin{matrix}{v}^{0} \\ {v}^{1} \\ ⋮ \\ {v}^{m}\end{matrix} ) \qquad ( 5 )$$

Applying polynomial functions may be used to estimate the total distorting effect in one general model, including those distortions that are very hard to be modeled and computed. Theoretically, the polynomials of infinite orders can compensate any type of distortions completely. With finite truncations of the Taylor series, it is possible to estimate the distortions with desired accuracy.

The present invention approximates the distortions caused by the flawed lenses and the components misalignment that display a pattern of continuous function. Random errors caused by noise may be incorporated, but are generally trivial compared to systematic errors and can only be described by polynomials of very high order. The degree of the polynomial function may be limited so that there is no excessive parameters for the random errors.

The accuracy of the distortions depends upon how many data points are available and the degree of polynomials (namely the size of the matrices m×n in (5)) must be decided. A matrix of 6×6 may suffice to reach sub-pixel accuracy in most cases.

This establishes the relation between the distortions and the ideal image points (u, v) in (4). Similarly, the polynomial function may be applied to the real image points (u′, v′), which provides:

$$( \begin{matrix}Δ u \\ Δ v\end{matrix} ) = g ( {u}^{′} , {v}^{′} ) = ( \begin{matrix}{\sum }_{i = 0 , j = 0}^{i = m , j = n} {c}_{ij} \cdot {u}^{′ i} {v}^{′ j} \\ {\sum }_{i = 0 , j = 0}^{i = n , j = m} {k}_{ij} \cdot {u}^{′ i} {v}^{′ j}\end{matrix} ) \qquad ( 6 )$$

Calibration Method:

The camera calibration involves finding the best fitting camera model for the real geometry of the camera. In an aspect of the present invention, the extracted image coordinates and the projected image coordinates are compared to minimize their difference.

The real image coordinates (u′ₑ, v′ₑ) of the target points may be extracted from the image, and from their 3D coordinates (x, y, z) the image coordinates (u′_{c}, v′_{c}) may be computed by using equations (1)-(4) (or using variation model (10)). Their difference can be shown as:

$$( \begin{matrix}Δ {u}^{′} \\ Δ {v}^{′}\end{matrix} ) = \vert ( \begin{matrix}{u}_{e}^{′} \\ {v}_{e}^{′}\end{matrix} ) - ( \begin{matrix}{u}_{c}^{′} \\ {v}_{c}^{′}\end{matrix} ) \vert \qquad ( 7 )$$

When the camera model describes the geometry of the camera perfectly and all the coordinates of the target points are given without error, δu and δv are 0. However, due to approximation and errors in data there is always residue in (δu, δv). The smaller the residue is, the better the camera model fits the real camera. The goal of the calibration is to find the camera model along with a set of parameters that minimize ((δu, δv)), which poses as a curve-fitting problem.

The coordinates of the target points are given in their own coordinate system (X, Y, Z) and must be transformed into camera reference frame (x, y, z) at first, which involves the extrinsic transformation (8). Since the position of the camera with regard to the target points' coordinate system is unknown, the extrinsic parameters R and T must be estimated in the curve-fitting as well.

$$( \begin{matrix}x \\ y \\ z\end{matrix} ) = R \cdot ( \begin{matrix}X \\ Y \\ Z\end{matrix} ) + T \qquad ( 8 )$$

where R is the rotation matrix; T is the translation (the coordinates of the origin of the target point reference frame in the camera reference frame); X, Y, Z are the coordinates in the target reference frame x; and y, z are the coordinates in the camera reference frame.

Now equation (1) may be applied on (x, y, z) to get (u′_{c}, v′_{c}), which involves estimating aᵢⱼ and bᵢⱼ in (4). If the projection function P contains additional parameters p, they are estimated in the curve-fitting as well.

Since the goal is the full calibration from world to image and the from image to world, the parameters of not only the forward distortion f in (4) (or (10)), but also the backward distortion g in (6) (or (11)) must be determined. The curve-fitting for each distortion must be carried out independently. Similar to (7), the difference of the undistorted coordinates are minimized:

$$( \begin{matrix}δ u \\ δ v\end{matrix} ) = \vert ( \begin{matrix}{u}_{e} \\ {v}_{e}\end{matrix} ) - ( \begin{matrix}{u}_{c} \\ {v}_{c}\end{matrix} ) \vert \qquad ( 9 )$$

where

$$( \begin{matrix}{u}_{e} \\ {v}_{e}\end{matrix} ) = g ( {u}_{e}^{′} , {v}_{e}^{′} )$$

$$( \begin{matrix}{u}_{c} \\ {v}_{c}\end{matrix} ) = P ( x , y , z )$$

To summarize, the parameters that need to be estimated in the curve-fitting are R, T, aᵢⱼ, bᵢⱼ, cᵢⱼ, kᵢⱼ, (P).

Variants of the General Polynomial Model:

Prior to this point, a general form has been established for the proposed model. Since it is still general, it can be further simplified and constrained so it would fit the geometry of the camera and the calibration process better. The following outlines two variants of the general form.

Straightforward Model for Coordinates:

The polynomial function may be used to relate the distorted image points (u′, v′) and the undistorted image points (u, v) directly, without the distortions (Δu, Δv). In this way the observed and the computed data points have the same magnitude rather than a difference of several degrees, which simplifies the numerical estimation process. The equations for this variation are:

$$( \begin{matrix}{u}^{′} \\ {v}^{′}\end{matrix} ) = \tilde{f} ( u , v ) = ( \begin{matrix}{\sum }_{i = 0 , j = 0}^{i = m , j = n} {\tilde{a}}_{ij} \cdot {u}^{i} {v}^{j} \\ {\sum }_{i = 0 , j = 0}^{i = n , j = m} {\tilde{b}}_{ij} \cdot {u}^{i} {v}^{j}\end{matrix} ) \qquad ( 10 )$$

and similarly:

$$( \begin{matrix}u \\ v\end{matrix} ) = \tilde{g} ( {u}^{′} , {v}^{′} ) = ( \begin{matrix}{\sum }_{i = 0 , j = 0}^{i = m , j = n} {\tilde{c}}_{ij} \cdot {u}^{′ i} {v}^{′ j} \\ {\sum }_{i = 0 , j = 0}^{i = n , j = m} {\tilde{k}}_{ij} \cdot {u}^{′ i} {v}^{′ j}\end{matrix} ) \qquad ( 11 )$$

The straightforward transformation between the distorted and the undistorted is then constructed. In this variation some of the coefficients can be geometrically interpreted. For instance (ã₀₀, \tilde{b}₀₀) is actually the offset of the principal point to image center. Similarly, ã₁₀, \tilde{c}₁₀ and \tilde{b}₀₁, \tilde{k}₀₁ are the scale factors for the u and v in forward and back-projections respectively, and if there is no error nor distortion, they should fulfill ã₁₀·\tilde{c}₁₀=1 and \tilde{b}₀₁·\tilde{k}₀₁=1.

However, this variation contains coefficients that are highly correlated to extrinsic rotation about the optical axis. When the image is rotated about the optical axis by θ, the rotated coordinates of image point (u, v) are presented as follows:

$$( \begin{matrix}\hat{u} \\ \hat{v}\end{matrix} ) = ( \begin{matrix}cos θ & sin θ \\ - sin θ & cos θ\end{matrix} ) ( \begin{matrix}u \\ v\end{matrix} ) \qquad ( 12 )$$

This expression may be replaced by the coefficients a₁₀, a₀₁, b₁₀ and b₀₁ in (10), which rewrites the equation as:

$$( \begin{matrix}\hat{u} \\ \hat{v}\end{matrix} ) = ( \begin{matrix}{a}_{10} & {a}_{01} \\ {b}_{10} & {b}_{01}\end{matrix} ) ( \begin{matrix}u \\ v\end{matrix} ) \qquad ( 13 )$$

The four coefficients in (13) together describe the rotation defined by one parameter θ. If the rotation angle θ is to be estimated in the extrinsic calibration, fitting these four coefficients to the camera model would disrupt the estimation of θ. Therefore, the rotation about the optical axis is prohibited in the intrinsic calibration by locking the four coefficients as a₁₀=1, a₀₁=0, b₁₀=0, and b₀₁=1.

Cap over Polynomial Degree:

Up to this point, full polynomials have been used to model the distortions of the fish-eye camera. While a large number of coefficients can approximate the distortions for the fish-eye cameras very accurately, they are not always optimal in light of modeling the true geometry of the camera and the computational performance.

Typically, the true geometry of the fish-eye camera is unknown, but it is known that the camera must follow a certain projection that converges a wide range of rays of light into the relatively small image area. The overall radial distortion should be monotonically increasing along the distance to distortion center, and remain smooth after including the residual distortions. In the model fitting of the polynomials, the data could be overfit if the polynomial degree is too high, making the overall radial distortion no longer smooth and possibly not monotone.

Furthermore, a large number of coefficients are very expensive for the numerical estimation. As long as the accuracy can be maintained, the number of coefficients should be reduced as much as possible to avoid excessive computational consumption.

A simple method to reduce the total number of coefficients is to discard the coefficients of high orders. We can set a cap or threshold for the degree of polynomials, and all terms of higher orders must be dropped. We suggest that the cap is defined as the larger value of the matrix dimensions (m, n). The new parameters would eventually be:

$${a}_{ij}^{′} = \{ \begin{matrix}{a}_{ij} , & for i + j \leq max ( m , n ) \\ 0 , & for i + j > max ( m , n )\end{matrix} \qquad ( 14 )$$

The updated matrix contains zeroes for terms higher than max(m, n). If the matrix is square, only the coefficients in the upper left triangular part of the matrix are estimated.

The cameras or sensors may comprise any suitable camera or sensor. Optionally, the cameras may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Pat. No. 9,126,525, which are hereby incorporated herein by reference in their entireties.

The imaging device and control and image processor and any associated illumination source, if applicable, may comprise any suitable components, and may utilize aspects of the cameras (such as various imaging sensors or imaging array sensors or cameras or the like, such as a CMOS imaging array sensor, a CCD sensor or other sensors or the like) and vision systems described in U.S. Pat. Nos. 5,760,962; 5,715,093; 6,922,292; 6,757,109; 6,717,610; 6,590,719; 6,201,642; 5,796,094; 6,559,435; 6,831,261; 6,822,563; 6,946,978; 7,720,580; 8,542,451; 7,965,336; 7,480,149; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2009/036176; WO 2009/046268; WO 2010/099416; WO 2011/028686 and/or WO 2013/016409, and/or U.S. Publication Nos. US 2010-0020170 and/or US-2009-0244361, which are all hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A camera calibration system for cameras of a vehicle, said camera calibration system comprising:
a plurality of cameras disposed at a vehicle and having respective fields of view exterior of the vehicle, wherein the fields of view of at least two of said cameras overlap, and wherein each of said cameras comprises an imager and a lens;
an image processor operable to process image data captured by said cameras;
wherein said image processor processes image data captured by said at least two of said cameras to determine features in the overlapping regions of the fields of view of said at least two of said cameras;
wherein said camera calibration system determines a best fitting camera model based on actual geometric properties of each of said cameras;
a display screen disposed in the vehicle for displaying images derived from image data captured by said at least two of said plurality of cameras for viewing by a driver of the vehicle during a driving maneuver of the vehicle; and
wherein, responsive to determining a best fitting camera model, the display screen displays images derived from image data captured by said at least two of said plurality of cameras and based at least in part on the best fitting camera model.

2. The camera calibration system of claim 1, wherein, responsive to processing by said image processor of image data captured by said at least two of said cameras, and responsive to determination of the best fitting camera model, said camera calibration system compares extracted image coordinates of determined features with projected image coordinates of determined features and minimizes their differences.

3. The camera calibration system of claim 1, wherein said camera calibration system uses a polynomial model to estimate a distortion effect of said lenses of said cameras.

4. The camera calibration system of claim 3, wherein the polynomial model comprises a single polynomial function to model radial and tangential distortions.

5. The camera calibration system of claim 1, wherein said plurality of cameras comprises at least four cameras for a surround view vision system of the vehicle.

6. The camera calibration system of claim 1, wherein said at least two of said cameras comprises a rearward viewing camera disposed at a rear of the vehicle and a sideward and rearward viewing camera disposed at a side of the vehicle.

7. The camera calibration system of claim 1, wherein said plurality of cameras comprises multiple cameras at the rear of the vehicle and multiple cameras at each side of the vehicle.

8. The camera calibration system of claim 1, wherein said at least two of said cameras each comprise a fish-eye lens providing a wide angle field of view for the respective camera.

9. A camera calibration system for cameras of a vehicle, said camera calibration system comprising:
a plurality of cameras disposed at a vehicle and having respective fields of view exterior of the vehicle, wherein the fields of view of at least two of said cameras overlap, and wherein each of said cameras comprises an imager and a fish-eye lens that provides a field of view greater than 180 degrees;
an image processor operable to process image data captured by said plurality of cameras;
wherein said image processor processes image data of said at least two of said cameras to determine features in the overlapping regions of the fields of view of said at least two of said cameras;
wherein said camera calibration system determines a best fitting camera model based on actual geometric properties of each of said plurality of cameras;
a display screen disposed in the vehicle for displaying images derived from image data captured by said at least two of said plurality of cameras for viewing by a driver of the vehicle during a driving maneuver of the vehicle; and
wherein, responsive to determining a best fitting camera model, the display screen displays images derived from image data captured by at least one of said plurality of cameras and based at least in part on the best fitting camera model.

10. The camera calibration system of claim 9, wherein, responsive to processing by said image processor of image data captured by said at least two of said cameras, and responsive to determination of the best fitting camera model, said camera calibration system compares extracted image coordinates of determined features with projected image coordinates of determined features and minimizes their differences.

11. The camera calibration system of claim 9, wherein said camera calibration system uses a polynomial model to estimate a distortion effect of said lens of said camera.

12. The camera calibration system of claim 9, wherein the polynomial model comprises a single polynomial function to model radial and tangential distortions.

13. The camera calibration system of claim 9, wherein said plurality of cameras comprises at least four cameras for a surround view vision system of the vehicle.

14. The camera calibration system of claim 13, wherein said at least two of said cameras comprises a rearward viewing camera disposed at a rear of the vehicle and a sideward and rearward viewing camera disposed at a side of the vehicle.

15. The camera calibration system of claim 9, wherein said plurality of cameras comprises multiple cameras at the rear of the vehicle and multiple cameras at each side of the vehicle.

16. A camera calibration system for cameras of a vehicle, said camera calibration system comprising:
a plurality of cameras disposed at a vehicle and having respective fields of view exterior of the vehicle, wherein the fields of view of at least two of said cameras overlap, and wherein each of said cameras comprises an imager and a lens;
an image processor operable to process image data captured by said cameras;
wherein said image processor processes image data of said at least two of said cameras to determine features in the overlapping regions of the fields of view of said at least two of said cameras;
wherein said camera calibration system determines a best fitting camera model based on actual geometric properties of each of said cameras by using a polynomial model to estimate a distortion effect of said lens of each of said at least two of said cameras, and wherein the polynomial model discards coefficients above a polynomial threshold;
a display screen disposed in the vehicle for displaying images derived from image data captured by said at least two of said plurality of cameras for viewing by a driver of the vehicle during a driving maneuver of the vehicle; and
wherein, responsive to determining a best fitting camera model, the display screen displays images derived from image data captured by said at least two of said plurality of cameras and based at least in part on the best fitting camera model.

17. The camera calibration system of claim 16, wherein, responsive to processing by said image processor of image data captured by said at least two of said cameras, and responsive to determination of the best fitting camera model, said camera calibration system compares extracted image coordinates of determined features with projected image coordinates of determined features and minimizes their differences.

18. The camera calibration system of claim 16, wherein said plurality of cameras comprises at least four cameras for a surround view vision system of the vehicle.

19. The camera calibration system of claim 16, wherein the polynomial model comprises a single polynomial function to model radial and tangential distortions.

20. The camera calibration system of claim 16, wherein each of said at least two of said cameras comprises a fish-eye lens providing a wide angle field of view for the respective camera.
